(19) United States
(12) Patent Application Publication
(10) Pub. No.: US 2003/0174228 A1
(43) Pub. Date: Sep. 18, 2003

(54) System for user-selectable image pre-processing in a digital camera

(76) Inventors: Wilfred F. Brake, Fort Collins, CO (US); Daniel M. Bloom, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/098,115

(22) Filed: Mar. 14, 2002

(51) Int. Cl. H04N 5/222

(52) U.S. Cl. 348/333.11; 348/222.1; 348/223.1

(57) ABSTRACT

A system that provides a mechanism for processing, by a digital camera, of an originally captured image, prior to the image being saved in a format that has a reduced amount of information relative to the original image. The system allows a user to select a number of preferred image characteristics and interactively edit photographic images before the images are compressed and downloaded from the camera. More specifically, the system allows a user to select one or more preferred image characteristic settings, capture an image, preview the captured image after it has been processed in accordance with the selected settings, re-select one or more different image quality settings to ‘edit’ the image, and re-preview until the processed image is satisfactory.

### FIELD OF THE INVENTION

The present invention relates generally to digital cameras, and more particularly, to a system for providing user-selectable image processing options after image capture and prior to storing a final image in local memory.

### BACKGROUND OF THE INVENTION

Statement of the Problem

Previously existing digital cameras record photographic images (i.e., ‘take pictures’) by the process of capturing a digital image, processing the image data, discarding the pre-processed image data, and saving the processed data as a photograph in a file in camera memory. In order to conserve on-board camera memory, the photograph (i.e., the processed image data) is typically saved in a compressed format that lacks some of the original image information.

A user often needs to post-process the digital images, i.e., to modify some of the characteristics of the images, such as color, brightness, contrast, or other image characteristics. However, due to the expense of small, dense memory modules used in digital cameras, it is presently not economically feasible to save the pre-processed (original) image data for subsequent processing. Therefore, since all original image data is discarded in order to minimize memory usage, the only data available for subsequent editing is data which has been previously processed. This poses a problem with respect to the quality of post-processed photographs, due to the fact that the saved, previously processed, images have been compressed and therefore do not contain all of the original information that was present in the pre-processed image data.

What is needed is a camera that allows a user to selectively and interactively customize and modify various characteristics of a captured image. In addition, it is desirable to allow a user to modify an image before the original image data is discarded, prior to any data compression or reduction, using the original, higher quality, pre-processed image data.

Solution to the Problem

The present system provides a mechanism for processing, by a digital camera, of an originally captured image, prior to the image being saved in a format that has a reduced amount of information relative to the original image. The present system allows a user to select a number of preferred image characteristics and interactively edit photographic images before the images are compressed and downloaded from the camera.

More specifically, the digital camera incorporating the novel features of the present system allows a user to:

(a) optionally select one or more preferred image characteristics settings (which have default values);

(b) capture an image (i.e., ‘take a picture’);

(c) review the captured image after it has been processed in accordance with the selected settings;

(d) re-select one or more different image characteristics to ‘edit’ the image; and

(e) repeat steps (c) and (d) until the processed image is satisfactory.

At step (a), a user may set one or more image characteristics such as brightness (exposure), contrast, color balance, etc.

In step (c), the camera processes the originally captured image and saves the processed image, but does not delete the original image. The camera displays the processed image on the camera's preview display (an LCD or other display device) so that the user may preview the image. If the user determines that the image requires further processing, then the user may edit the image by adjusting one or more image characteristics such as brightness, contrast, color balance, etc. After the image characteristics have been adjusted, a preview button is pressed, or alternatively, the image changes dynamically as the user makes the adjustments, and the image is re-processed in accordance with the adjusted image characteristics and displayed (previewed) again. When the user is satisfied with the processed image, the originally captured image is deleted when the shutter button is pressed to take the next picture.

Heretofore, image processing was only possible offline, i.e., after images were downloaded from a camera to a computer, thus incurring degradation in the image quality of the post-processed compressed images. In fact, on-board, post-capture image processing was previously not available with any kind of camera, irrespective of the image quality issue. Although dozens of various types of digital cameras have been engineered, no previous camera has provided the capability of allowing a user to modify a captured (photographed) image using the originally captured image data, or to modify the image characteristics of a captured image before the image was downloaded from the camera.

The present system provides the capability to selectively and interactively customize and modify various characteristics of a captured image before the image is downloaded to a computer for offline post-processing. The image may be modified (i.e., edited) before the original image data is discarded, prior to any data compression or reduction, using the original, higher quality, pre-processed image data. The resulting photographs are therefore of higher quality than photographs which have been preprocessed, compressed, and then post-processed after being downloaded.

### BRIEF DESCRIPTION OF THE DRAWINGS

FIGS. 1A and 1B are diagrams showing exemplary functional blocks in a digital camera used in the present system;

FIG. 2 is a flowchart illustrating basic steps employed in carrying out the present system; and

FIG. 3 is a flowchart illustrating, in greater detail, image processing functions shown in FIG. 2.

### DETAILED DESCRIPTION

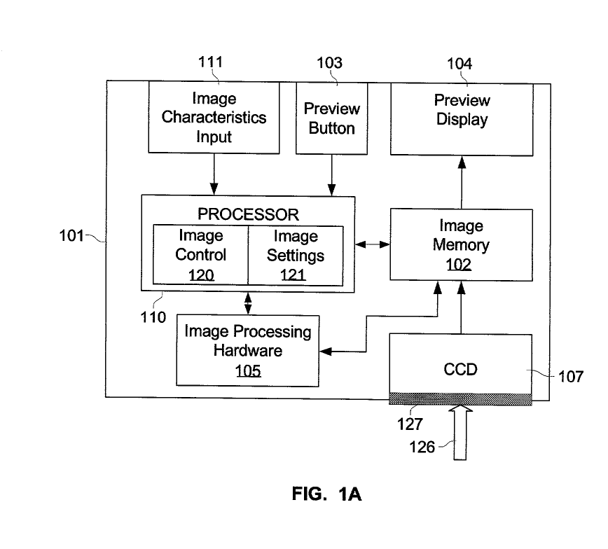

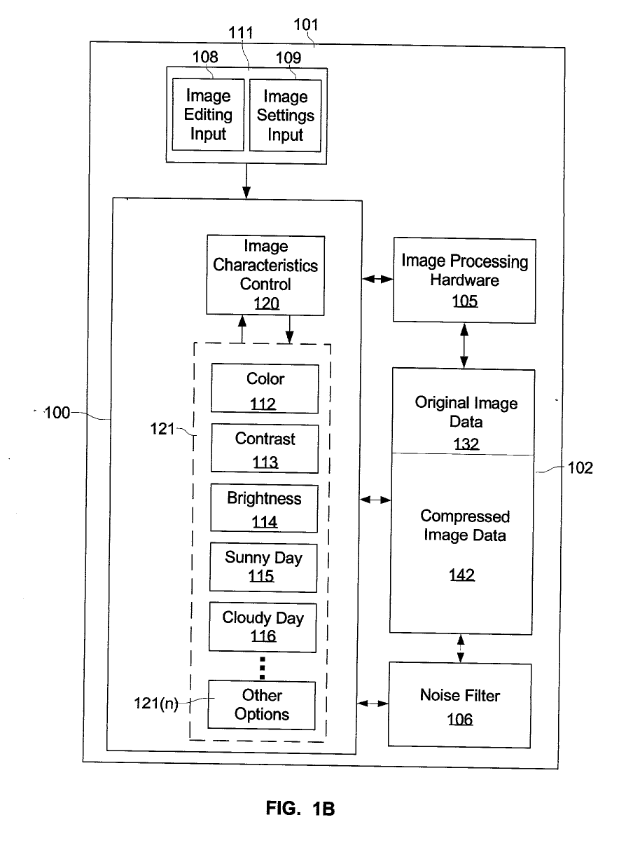

FIGS. 1A and 1B are diagrams showing exemplary functional blocks in a digital camera used in the present system. FIG. 1A illustrates components of interest in a digital camera 101 programmed in accordance with the present system. As shown in FIG. 1, camera 101 comprises a light receiving device 107, such as a CCD or CMOS imager, processor 110, image processing hardware 105, and an image memory module 102. In an exemplary embodiment, light receiving device 107 is a CCD imager that detects light 126, input through camera lens 127, from the subject to be photographed.

Camera 101 further comprises a preview display 104, for example, an LCD device, a preview button or switch 103 for enabling the preview display, and an image characteristics input mechanism 111 including an image editing input 108 and an image settings input 109 for manual input of preferred image characteristics and image editing parameters, respectively. Processor 110 includes an image characteristics control component 120 and associated image settings data storage 121 which indicates user-selected image editing parameters including color balance 112, contrast 113, and brightness 114, may also used in conjunction with the ‘preferred’ settings and preferred image characteristics settings, as explained below with respect to FIG. 1B.

FIG. 1B illustrates, in further detail, certain exemplary aspects of image characteristics control function 120 and associated image settings data 121. Input mechanism 111 includes an image editing input 108 for manual input of image editing parameters, and an image settings input 109 for manual input of preferred image characteristics that determine how the initially captured image is to be processed. The user may input the image settings via a selector switch or displayable menu, etc., both prior to capturing an image and after previewing a captured image, to edit the image.

Preferred image characteristics include settings such as ‘sunny day’ 115, cloudy day’ 116, and other options 121(n) such as ‘sports mode’, etc. Image characteristics control component 120 is coupled to input mechanism 111 for receiving user-selected image characteristics, which are converted into appropriate parameters that are stored in image settings data storage 121. For example, ‘sunny day’ sets the color, contrast, and brightness to certain values that generally work well in sunlight. ‘Sports mode’, for example, causes selection of a faster than normal shutter speed and a commensurately larger aperture setting (i.e., lower ‘f stop’). The user can then further adjust the settings using color, contrast, and brightness settings. By default, an image is typically exposed using the EV value for the image, unless an image characteristics setting is selected that overrides the default exposure process. It is assumed that traditional, exposure algorithms, well-known in the art, yield adequate data for later processing.

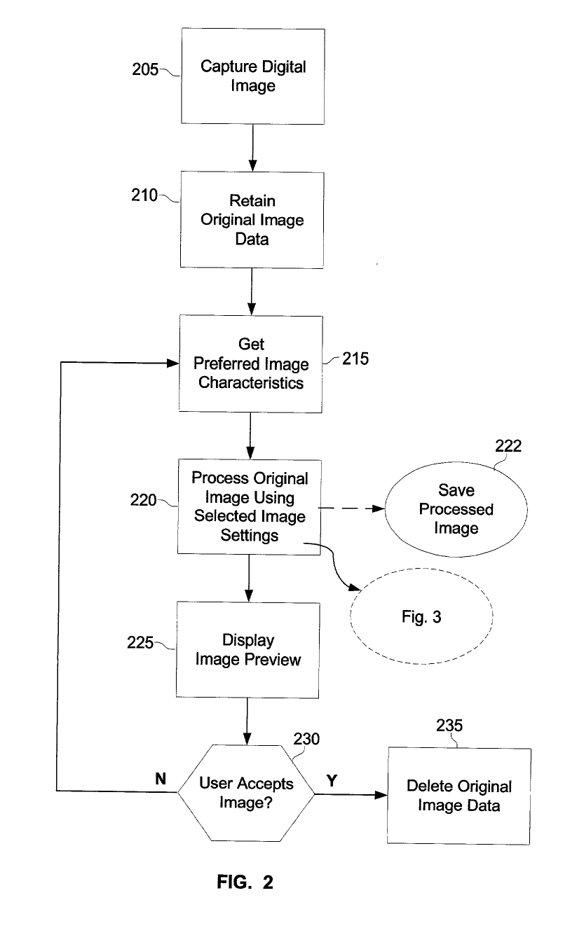

Block 121 is shown in dotted lines, indicating that image settings data 121 may be stored in memory that is shared between processor 110 and image processing hardware 105, or the data may be stored in processor registers. Image processing hardware 105 operates on original data captured directly from light receiving device 107, which is stored as original image data 132 in image memory 102. Image processing hardware 105 functions in response to commands, from image characteristics control component 120, to convert original image data 132 to compressed image data 142, in accordance with parameters stored in image settings data storage 121. Compressed image data 142 is also stored in image memory 102. As part of the image processing procedure, the original image data 132 is processed by noise filter 106, as necessary, to remove noise from the image. Image processing (initial processing and subsequent editing) is described below in greater detail with respect to FIG. 2. It should be noted that component functions shown as being integral to processor 110 may be optionally implemented by software or firmware. In any event, the functions performed by blocks 105, 106, and 120 are initiated in response to commands from processor 110.

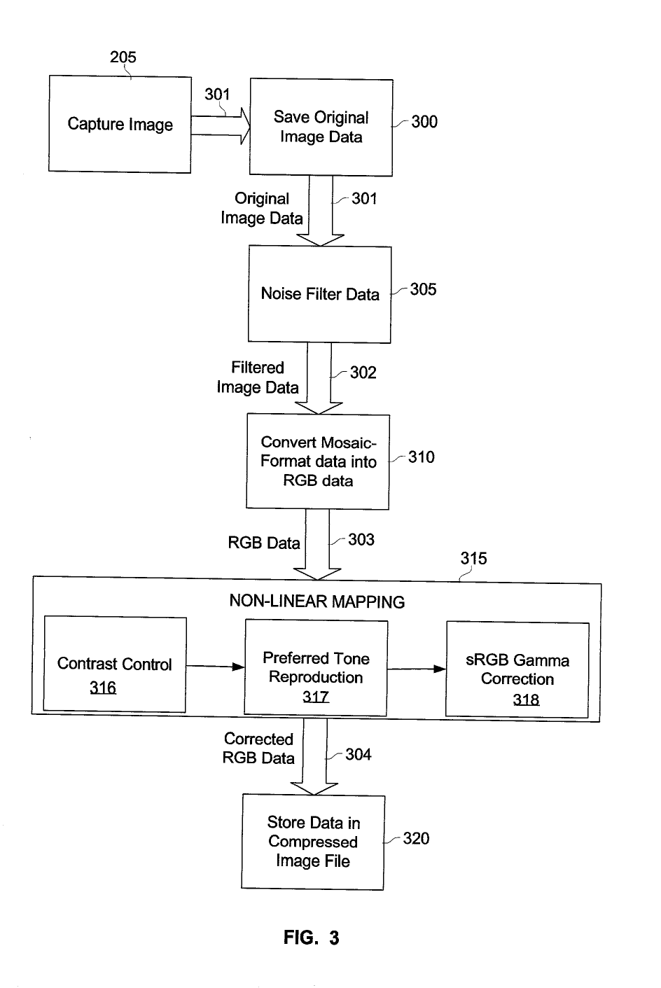

FIG. 2 is a flowchart illustrating basic steps employed in carrying out the present system. As shown in FIG. 2, at step 205, the user ‘takes a picture’ with camera 101, causing the camera to capture a digital image via light receiving device 107. At step 210, this original image is stored in image memory 102, where it is retained for subsequent processing. The original image is typically saved in a mosaic pixel pattern, as described below with respect to FIG. 3.

At step 215, image control component 120 reads image characteristics input 111 (or, alternatively, uses default values) to determine how the originally captured image is to be processed. Parameters corresponding to these preferred image characteristics are then stored in image settings data storage 121. Step 215 may be initiated in response to two different situations, wherein:

(1) A user initially selects the preferred image characteristics that determine how the initially captured image is to be processed, via image setting input 109, and takes a picture with camera 101. If no image characteristics settings are selected by the user specifically for this picture, the previously selected settings, or alternatively, default values, are used by processor 110/image processing hardware 105.

(2) After a picture has been taken, the original image data 132 is saved, and the image is initially processed; the user then presses preview button 103, after having entered all of the desired image editing settings via image editing input 108.

At step 220, the original image data stored in image memory 102 is processed by image processing hardware 105, using the parameters in image settings data storage 121. The processed image is typically a compressed 8 bit RGB image, as described below with respect to FIG. 3, which describes step 220 in greater detail. At step 222, the processed image is stored in a file in compressed image data storage 142, and at step 225 the processed image is displayed on preview display 104.

At step 230, if the user decides that the processed image is acceptable, then no further action is by the user necessary, as the original image data 132 is deleted (at step 235) when the next picture is taken. In an alternative embodiment, the camera saves the data (in memory 102) from two or more original images to allow further on-board processing (re-editing) by the user subsequent to the image capture, after other pictures have been taken. If more than one original image is saved, the images may be deleted as necessary, depending on the amount of available memory 102, as additional images are captured. If, at step 230, the user decides that additional editing of the image is desirable, then editing (re-processing) of the originally captured image takes place, back at step 215.

FIG. 3 is a flowchart illustrating, in greater detail, image processing functions shown in step 220 of FIG. 2. At step 205 (in both FIGS. 2 and 3), a digital image is captured. As shown in FIG. 3, at step 300, the original image data 301 is stored in original image data area 132.

At step 305, CCD data 301, detected by light receiving device 107, is filtered by noise filter 106 to generate noise-filtered CCD data 302. Depending upon how much the user wants to brighten or darken an image, this step may be omitted during the processing (editing) of certain images. If the user brightens an image a great deal, then additional noise filtering (after the initial image processing) may be necessary. Data from light receiving device 107 is typically in the format:

R G R G R G . . .
G B G B G B . . .

where the data representation is R=red, G=green, and B=blue.

At step 310, the CCD data 302, which is in a mosaic format, is converted into RGB data 303. RGB Data is typically in the format:

RGB RGB RGB . . .
RGB RGB RGB . . .

At step 315, the RGB data is converted for non-linear display, typically for tone-mapping and contrast control. In an exemplary embodiment of the present system, 14 bit data is converted into 8 bit data at step 315; i.e., the data from step 310 is 14 bit RGB, and the data out of step 315 is effectively 8 bit RGB. In step 315, RGB data 303 is converted for non-linear displays, per sRGB standard gamma correction. In one embodiment of the present system, a non-linear line of RGB data 303 is found for contrast and tone-mapping, and this line is merged with the standard non-linear line of the sRGB specification to make one line that is used in step 315. In an alternative embodiment, three separate steps, including contrast adjustment 316, preferred tone reproduction 317, and sRGB gamma curve correction 318, are performed on the RGB date 303. Steps 315 and 316 are performed in accordance with the image processing settings acquired in step 215 in FIG. 2. RGB data 304 corrected in accordance with the sRGB gamma curve is stored in compressed image data storage 142 at step 320, also used as display data for input to preview display 104.

Since the original image data 301 is not deleted until a subsequent exposure is taken, every step in FIG. 3 is performed every time the user changes one or more image characteristics settings. Original image data 301 must be converted, in accordance with the sRGB standard, in order to drive typical non-linear displays, such as preview display device 104. This conversion is one reason why image information is lost when an image is processed. The present system, therefore, advantageously processes original image data 301 every time an image is edited.

While exemplary embodiments of the present invention have been shown in the drawings and described above, it will be apparent to one skilled in the art that various embodiments of the present invention are possible. For example, the functional blocks shown in FIGS. 1A and 1B, as well as the specific sequence of steps described with respect to FIGS. 2 and 3, should not be construed as limited to the specific embodiments described herein. Modification may be made to these and other specific elements of the invention without departing from its spirit and scope as expressed in the following claims.

We claim:

1. A system for processing an image by a digital camera comprising: capturing an image with the camera to create an originally captured image; saving the originally captured image in a first format;
processing the originally captured image, in accordance with a first set of parameters, to generate a first processed image in a second format; and
editing the originally captured image, in accordance with a second set of parameters input by a user of the camera, to generate a second processed image in said second format.

2. The system of claim 1, wherein the second processed image is saved in memory in the camera.

3. The system of claim 1, wherein the second format is compressed with respect to the first format.

4. The system of claim 3, wherein the second format is an RGB format.

5. The system of claim 1, wherein the first processed image is displayed for previewing prior to the editing step.

6. The system of claim 1, wherein said parameters are selected from the set of parameters consisting of image contrast, image brightness, and color balance.

7. The system of claim 1, wherein said second format is compressed relative to said first format.

8. The system of claim 1, wherein the second processed image is deleted prior to processing a subsequently captured image.

9. The system of claim 1, wherein each said originally captured image is saved for additional processing subsequent to the capture thereof, after a plurality of images have been captured.

10. The system of claim 1, wherein said first processed image is displayed on a display device for previewing said first processed image before the first processed image is edited.

11. The camera of claim 1, wherein said parameters are indicative of image characteristics selected from the group consisting of image contrast, image brightness, and color balance.

12. A digital camera comprising:
memory for storing an original image captured by the camera,
an input mechanism for receiving, after said original image is captured,
input indicative of preferred image characteristics;
image processing hardware, coupled to the computer and to said memory;
wherein said image processing hardware processes said original image in accordance with input from said input mechanism.

13. The camera of claim 12, further comprising a display device for previewing said image after the image has been processed; wherein said image processor processes said original image in accordance with input from said input mechanism, after the image has been displayed on the display device.

14. The camera of claim 12, wherein said input mechanism comprises a displayable menu.

15. The camera of claim 12, wherein said input comprises parameters indicative of image characteristics selected from the group consisting of image contrast, image brightness, and color balance.

16. The camera of claim 12, further comprising a processor, coupled to said memory and to said image processing hardware, that deletes said original image from said memory before a subsequent image is captured by the camera.

17. The camera of claim 12, further comprising a processor, coupled to said memory and to said image processing hardware, that deletes said original image from said memory after a subsequently captured image is processed by the camera.

18. The camera of claim 12, wherein the camera saves each said original image for additional processing subsequent to the capture thereof, after a plurality of images have been captured.

19. A system for processing an image by a digital camera comprising:
capturing an image with the camera to create an originally captured image;
saving the originally captured image in a first format;
processing the originally captured image, in accordance with a first set of parameters input by a user of the camera, to generate a first processed image in a second format;
displaying the first processed image;
editing the originally captured image, in accordance with a second set of parameters input by a user of the camera, to generate a second processed image in said second format;
saving the second processed image; and
deleting the originally captured image.

20. The system of claim 19, wherein said parameters are indicative of image characteristics selected from the group consisting of image contrast, image brightness, and color balance.
